(19) United States
(12) Patent Application Publication
(10) Pub. No.: US 2021/0355009 A1
(43) Pub. Date: Nov. 18, 2021

(54) WATER TREATMENT APPARATUS AND WATER TREATMENT SYSTEM

(71) Applicants: KABUSHIKI KAISHA TOSHIBA, Tokyo (JP); Toshiba Infrastructure Systems & Solutions Corporation, Kanagawa (JP)

(72) Inventors: Jinyang HU, Inagi Tokyo (JP); Takumi OBARA, Fuchu Tokyo (JP); Miwa SAITO, Meguro Tokyo (JP); Shinobu MONIWA, Kawasaki Kanagawa (JP); Kenji KAKINUMA, Ota Tokyo (JP); Nobuhiro OOTSUKI, Suginami Tokyo (JP)

(21) Appl. No.: 17/322,787

(22) Filed: May 17, 2021

(30) Foreign Application Priority Data
May 18, 2020 (JP) 2020-086717

(51) Int. Cl. C02F 3/08; C02F 3/34; C02F 3/00

(52) U.S. Cl. CPC C02F 3/082; C02F 3/34; C02F 2303/20; C02F 2203/006; C02F 3/006

(57) ABSTRACT

A water treatment apparatus includes a flat plate and a remover. The flat plate rotates so as to be partially immersed in raw water and to which microorganisms that purify the raw water are attached. The remover removes part of the microorganisms adhering to the flat plate.

### CROSS-REFERENCE TO RELATED APPLICATIONS

This application is based upon and claims the benefit of priority from Japanese Patent Application No. 2020-086717, filed on May 18, 2020, and the entire contents of which are incorporated herein by reference.

### FIELD

An embodiment described herein relates generally to a water treatment apparatus and a water treatment system.

### BACKGROUND

In water treatment systems that purify organic effluent containing organic matters such as sewage, biological treatment by microorganisms (hereinafter referred to as “microbial treatment”) is generally used. (The word microbial treatment may be referred as microorganism treatment)

One of the water treatment systems utilizing this type of microbial treatment is a water treatment system using a rotating disk process. (JP2007-301511A, JP2009-166038A)

It is known that domination of Bacillus bacteria allows the amount of excess sludge generated in the water treatment process to be reduced, generation of odor to be suppressed, and good organic matters and nitrogen removal performance can be obtained. It is also known that as disclosed in JP2000-189991A, when a biological reaction tank of the activated sludge process is placed in a subsequent stage of the water treatment process, the load of the biological reaction tank can be reduced, and it is therefore possible to achieve effects such as that the power consumption of the blower of the biological reaction tank can be significantly reduced.

On the other hand, if microorganisms excessively adhere to the disk-like flat plate, oxygen cannot be sufficiently supplied to the microorganisms inside of the disk-like flat plate, and contact between raw water and the microorganisms inside of the flat plate is hindered, and hence the water purification performance of the flat plate remarkably deteriorates.

### DESCRIPTION OF THE DRAWINGS

FIG. 1 is a view showing a configuration of a water treatment apparatus according to a first embodiment as viewed from above.

FIG. 2 is a view showing a configuration of the water treatment apparatus according to the first embodiment as viewed from an introduction side of a raw water.

FIG. 3 is a view showing a configuration of a water treatment apparatus of a modification 1 of the first embodiment as viewed from the introduction side of the raw water.

FIG. 4 is a view showing a configuration of the water treatment apparatus of the modification 1 of the first embodiment as viewed from the side surface side.

FIG. 5 is a view showing a configuration of a water treatment apparatus of a modification 2 of the first embodiment as viewed from the introduction side of the raw water.

FIG. 6 is a view showing a configuration of a water treatment apparatus according to a second embodiment as viewed from the introduction side of the raw water.

FIG. 7 is a view showing a configuration of a water treatment apparatus of a modification 1 of a second embodiment as viewed from the side surface side.

FIG. 8 is a view showing a configuration of a water treatment apparatus of a modification 2 of the second embodiment as viewed from the introduction side of the raw water.

FIG. 9 is a view showing a configuration of a sterilization agent ejection section in the water treatment apparatus of the modification 2 of the second embodiment.

FIG. 10 is a view showing a configuration of a water treatment system according to a third embodiment as viewed from the introduction side of the raw water.

FIG. 11 is a view showing a configuration of the water treatment system according to the third embodiment as viewed from above.

FIG. 12 is a block diagram showing a functional configuration of a control section in the water treatment system according to the third embodiment.

FIG. 13 is a view showing a configuration of a water treatment system of a modification 1 of the third embodiment as viewed from above.

FIG. 14 is a block diagram showing a functional configuration of a control section in the water treatment system according to the modification 1 of the third embodiment.

FIG. 15 is a graph illustrating a relationship between the amount of microorganisms adhering to the flat plate when the number of rotations per unit time is the same and a motor current value obtained when the flat plate rotates.

FIG. 16 is a view showing a configuration of a water treatment system of a modification 2 of the third embodiment as viewed from the side surface side.

FIG. 17 is a block diagram showing a functional configuration of a control section in the water treatment system according to the modification 2 of the third embodiment.

FIG. 18 is a view showing a configuration of a water treatment system of a modification 3 of the third embodiment as viewed from the side surface side.

FIG. 19 is a block diagram showing a functional configuration of a control section in the water treatment system according to the modification 3 of the third embodiment.

### DETAILED DESCRIPTION

Representative embodiments will be described below with reference to the drawings.

The embodiments are not limited to the following. In the following description, parts identical to previously described parts are indicated by using identical reference numerals, and duplicate description is avoided.

### First Embodiment

A water treatment apparatus 100 according to the first embodiment will be described.

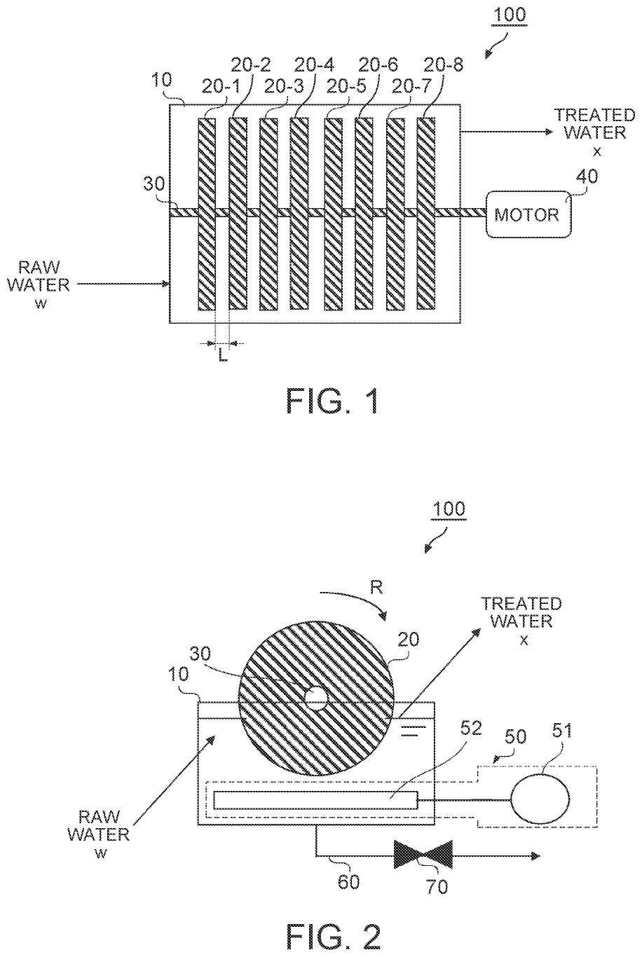

FIG. 1 is a view showing the configuration of the water treatment apparatus 100 according to the first embodiment as viewed from above.

FIG. 2 is a view showing the configuration of the water treatment apparatus 100 according to the first embodiment as viewed from the introduction side of the raw water w.

A water treatment apparatus 100 is an apparatus that purifies raw water such as organic effluent (drainage) such as sewage, agricultural effluent, and industrial effluent by microbial treatment utilizing microorganisms such as Bacillus . As shown in FIG. 1, the water treatment apparatus 100 includes a water treatment tank 10, a flat plate 20, a rotary shaft 30, and a motor 40. As shown in FIG. 2, the water treatment apparatus 100 further includes a removal section 50 (remover), a sludge drawing pipe 60, and a sludge drawing valve 70. The Bacillus may be referred as Bacillus or Bacillus bacteria.

As shown in FIG. 1, the water treatment tank 10 is a container into which raw water w is introduced. As a process, the subsequent stage of the water treatment apparatus 100 is not limited. A setting basin may be placed in the subsequent stage, and the solid content exfoliated (peeled off) from the flat plate 20 by the water treatment apparatus 100 may be precipitated and separated to discharge treated water x, or the subsequent stage may have a biological treatment process such as a standard activated sludge process. The “raw water w” mentioned here is water to be treated by the water treatment apparatus 100, and includes water being treated by the water treatment apparatus 100. The “treated water x” is water having been treated by the water treatment apparatus 100.

A plurality of the flat plates 20 are placed in the water treatment tank 10 in parallel at a constant interval L. The flat plate 20 is a rotating disk body. Each flat plate 20 is installed in the water treatment tank 10 so that each flat plate 20 is not entirely immersed in raw water but a part of the lower side is immersed in the raw water w, and the upper side relative to the part immersed in the raw water w is in the gas phase. Thus, each flat plate 20 comes into contact with air on the upper side, and is immersed in the raw water w the lower side. Such a configuration is achieved by, for example, horizontally placing the rotary shaft 30 described later at a height substantially equal to the height of the upper edge of the water treatment tank 10. Thus, even if the water treatment tank 10 is filled with the raw water w, only the lower half of the flat plate 20 is immersed in the raw water w, and hence at least the upper half comes into contact with air. On the surface of each flat plate 20, a contact body for making microorganisms such as Bacillus bacteria to dominantly and easily adhere is placed. The contact body can be configured with a fibrous contact body, but the specific configuration is not particularly limited. The flat plate 20 may be porous so as to have a large number of microorganisms. Each flat plate 20 is provided with a through hole at the center of the circle. Microorganisms are planted in the contact body by adhering the microorganisms. For example, US 2010/0247837 A1 also mentions a contact body using microorganism, the entire contents of which are incorporated herein by reference.

The rotary shaft 30 is inserted into and fixed to a through hole at the center of the circle provided in each flat plate 20. The flat plates 20 are placed in parallel along the long axis direction of the rotary shaft 30 at the constant interval L.

The motor 40 rotates the rotary shaft 30 by a drive force. Thus, as shown by an arrow R shown in FIG. 2, each flat plate 20 rotates about the rotary shaft 30. A rotation speed of the rotary shaft 30 and each flat plate 20 is, for example, 10 rpm during normal operation of the water treatment apparatus 100. Thus, by each flat plate 20 rotating with the rotation of the rotary shaft 30 as shown by the arrow R shown in FIG. 2, the microorganisms adhering to the contact body take in oxygen from the air, and oxidize and decompose organic components in the raw water w. Nitrogen components in the raw water w are also oxidized at the same time, converted into NOx, and then a denitrification reaction occurs by the action of anaerobic microorganisms inhabiting the inside of each flat plate 20, thereby removing the nitrogen components. Thus, the treated water x in which the organic matters and the nitrogen components have been removed from the raw water w is discharged from the water treatment tank 10. However, with the continuation of such a purification operation, the microorganisms adhering to the contact body, i.e., the surface of the flat plate 20, proliferate. If the microorganisms adhering to the flat plate 20 proliferate excessively, sufficient oxygen will not be distributed to the microorganisms adhering to the flat plate 20, and the purification performance deteriorates. Furthermore, insufficient oxygen sometimes causes adverse effects such as an increase in odor due to the progress of each flat plate 20 becoming anaerobic and a decrease in transparency of the treated water x. Therefore, when microorganisms excessively adhere to the flat plate 20, it is necessary to reduce the amount of the excessively adhering microorganisms by removing part of the microorganisms.

The removal section 50 (remover) reduces the amount of the excessively adhering microorganisms so that the adhesion amount of the microorganisms adhering to the flat plate 20 is kept within an appropriate range. The removal section 50 includes a blower 51 and a diffuser tube 52, as an example of applying a physical action to the flat plate 20.

The blower 51 is provided outside the water treatment tank 10 and sends air to the diffuser tube 52 to be described later.

The diffuser tube 52 is installed below the flat plate in the water treatment tank 10. The surface of the diffuser tube 52 is provided with a multitude of small holes, and the air supplied from the blower 51 becomes bubbles when passing through the holes, rises in the raw water w, and collides with the flat plate 20 positioned above the diffuser tube 52, thereby applying a physical action. The microorganisms excessively adhering to the flat plate 20 are removed from the flat plate 20 by collision of bubbles from below or by upward flow generated by bubbles.

The sludge drawing pipe 60 is connected to the bottom surface of the water treatment tank 10.

The sludge drawing valve 70 is provided in the sludge drawing pipe 60. By the opening operation of the sludge drawing valve 70, the microorganisms accumulated at the bottom of the water treatment tank 10 are discharged from the water treatment tank 10 through the sludge drawing pipe 60. The opening operation of the sludge drawing valve 70 is performed by stopping the introduction of the raw water w into the water treatment tank 10. After the excessive microorganisms are discharged from the water treatment tank 10, the closing operation of the sludge drawing valve 70 is performed to resume (reopen) the introduction of the raw water w into the water treatment tank 10.

Next, the operation of the removal section 50 will be described.

The blower 51 of the removal section 50 operates by receiving a command to clean the flat plate 20. When the blower 51 of the removal section 50 operates, bubbles are generated from the holes of the diffuser tube 52, and it becomes possible to clean the flat plate 20.

Cleaning of the flat plate 20 with bubbles is carried out for a predetermined time (continuous cleaning is performed for several minutes). At the time of cleaning, the flat plate 20 is rotated. The rotation speed of the flat plate 20 at the time of cleaning may be freely set. It is desirable to stop the inflow of the raw water w into the water treatment tank 10 at the time of cleaning, but cleaning may be carried out while letting the raw water w flow into the water treatment tank 10. If the inflow of the raw water w to the water treatment tank 10 is stopped at the time of cleaning or after end of cleaning, the inflow of the raw water w is resumed at the end of cleaning.

The microorganisms exfoliated from the flat plate 20 by the removal section 50 may be recovered (collected) in the water treatment tank 10 and the microorganisms may be discharged from the sludge drawing pipe 60. The microorganisms exfoliated from the flat plate 20 by the removal section 50 may not be discharged from the sludge drawing pipe 60 because they are hydrolyzed as they are in the water treatment tank 10 and no excess sludge is generated.

The water treatment apparatus 100 according to the present embodiment becomes possible to remove microorganisms excessively adhering to the flat plate 20, and to stabilize the water treatment performance (prevent of deterioration of the treated water quality).

Further, the present embodiment provide a water treatment apparatus capable of reliably exfoliating excessively adhering microorganisms, dominating Bacillus bacteria, which is an effective microorganism, and always maintaining high treatment performance.

Since the amount of microorganisms excessively adhering to the flat plate 20 can be reduced by the removal section 50, the water treatment apparatus 100 according to the present embodiment becomes possible to reduce the workload of the maintenance manager of the water treatment facility and to save manpower.

### Modification 1 of First Embodiment

In the modification 1 of the first embodiment, unlike the above-described first embodiment, the removal section has a water sprinkling mechanism.

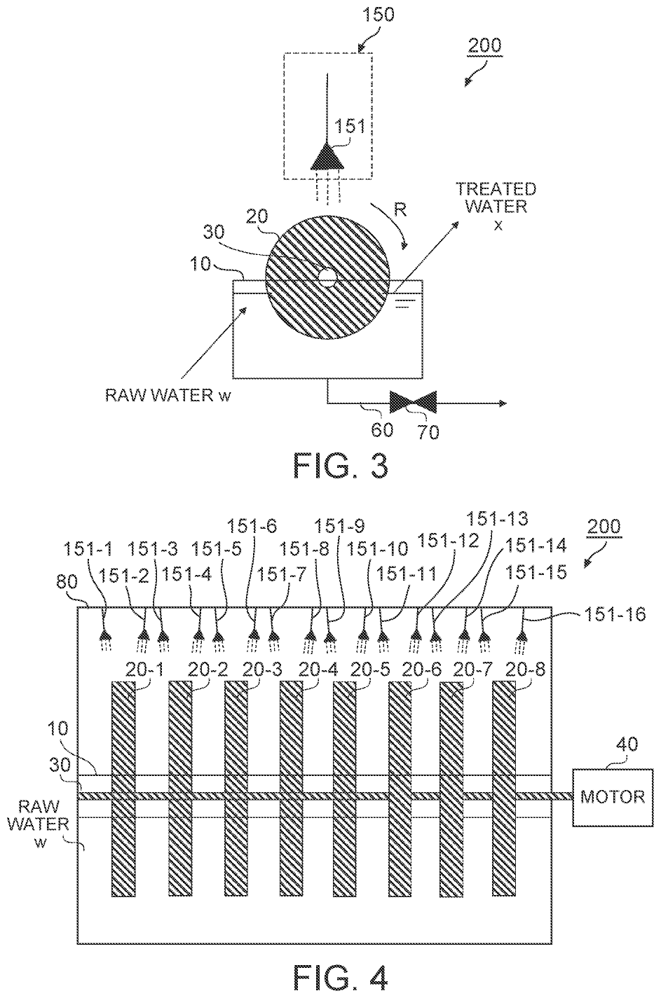

FIG. 3 is a view showing a configuration of a water treatment apparatus 200 of the modification 1 of the first embodiment as viewed from the introduction side of the raw water w. A water sprinkling section 151 of the removal section 150 is placed on the side or upper part of the flat plate 20, operates a water sprinkling pump (not illustrated) upon receiving a cleaning command, and ejects a fluid such as water to the flat plate 20 while the flat plate 20 is rotated, thereby applying a physical action to the flat plate 20. Thus, exfoliation (peel off) and cleaning of the surface of the flat plate 20 are performed by the flow of fluid.

Depending on the placement position of the water sprinkling section 151, the angle at which the fluid such as ejected water collides with the flat plate 20 can be changed. By reducing the angle at which the ejected fluid collides with the flat plate 20, excessive microorganisms can be exfoliated. In addition, the output of the sprinkler pump can increase the flow rate of the fluid, and it is hence possible to exfoliate a Spirogyra-like biofilm formed by microorganisms such as Sphaerotilus natans, which is difficult to be exfoliated by cleaning with bubbles in the first embodiment. In a case where the area of the flat plate 20 is large, uneven cleaning tends to occur in the fixed water sprinkling section 151 at only one place, and hence in order to uniformly clean the flat plate 20. For the reason, it is desirable to place a movable water sprinkling section 151 or a plurality of water sprinkling sections 151 at a plurality of locations.

FIG. 4 is a view showing the configuration of the water treatment apparatus 200 of the modification 1 of the first embodiment as viewed from the side surface side. FIG. 4 is an example in which the water sprinkling sections 151 are placed at a plurality of locations. As shown in FIG. 4, by having a configuration in which the water sprinkling sections 151 are placed at a plurality of positions, the water treatment apparatus 200 can uniformly clean both surfaces of a plurality of flat plates 20-1 to 20-8. The water treatment apparatus 200 has a housing cover 80, and the water sprinkling section 151 may be attached to the housing cover 80. As shown in FIG. 4, the water treatment apparatus 200 may include the plurality of water sprinkling sections 151 for cleaning one flat plate 20. The plurality of water sprinkling sections 151 may have a configuration in which each of them has a valve and can adjust the flow rate of the fluid ejected from each water sprinkling section 151. The fluid ejected by the water sprinkling section 151 is not particularly limited, but in order to minimize the water treatment load fluctuation of the entire apparatus when cleaning, it is desirable to be the treated water x discharged from the water treatment apparatus 200. That is, the fluid ejected from the water sprinkling section 151 is desirable to be the treated water x in which the raw water w has been purified by microorganisms.

The microorganisms exfoliated from the flat plate 20 may be recovered (collected) in the water treatment tank 10 and the microorganisms may be discharged from the sludge drawing pipe 60. The microorganisms exfoliated from the flat plate 20 may not be discharged from the sludge drawing pipe 60 because they are hydrolyzed as they are in the water treatment tank 10 and no excess sludge is generated.

Thus, according to the present modification, the removal effect in microorganism removal can be further enhanced, and the microbial films that have been difficult to be removed can be exfoliated from the flat plate 20.

### Modification 2 of First Embodiment

In the modification 2 of the first embodiment, unlike the above-described first embodiment, the removal section has a scraping mechanism.

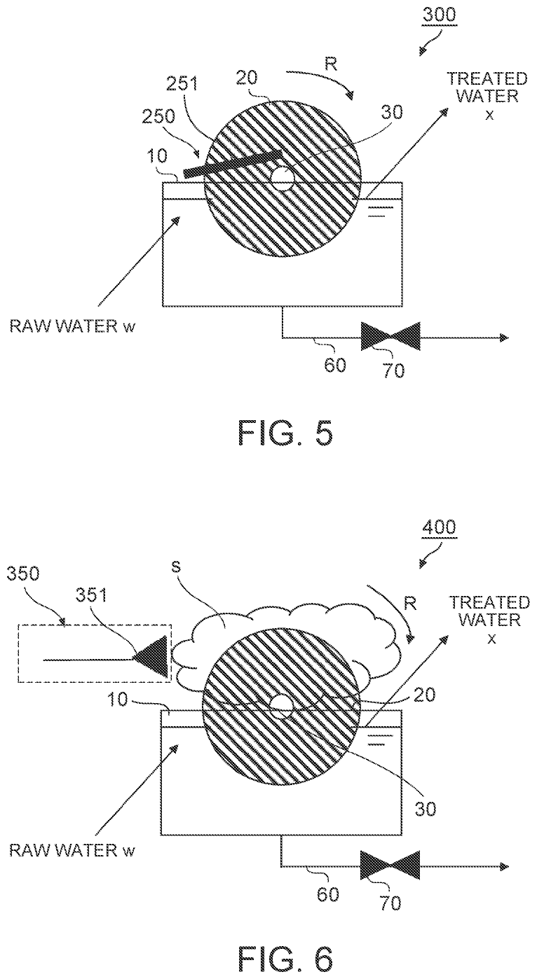

FIG. 5 is a view showing the configuration of a water treatment apparatus 300 of the modification 2 of the first embodiment as viewed from the introduction side of the raw water w. As an example of applying a physical action to the flat plate 20, a removal section 250 has a scraping member 251 that is pressed against the surface of the flat plate 20 to exfoliate (peel off) microorganisms from the flat plate 20. The scraping member 251 is placed near the flat plate 20 and operates so as to be pressed against the flat plate 20 upon receiving a removal command. When the scraping member 251 is pressed against the flat plate 20, the flat plate 20 is rotated, and microorganisms excessively adhering to the flat plate 20 are scraped off and exfoliated by the operation of the water treatment apparatus 300. The scraped microorganisms may be recovered (collected) in the water treatment tank 10 and the microorganisms may be discharged from the sludge drawing pipe 60. The microorganisms exfoliated from the flat plate 20 may not be discharged from the sludge drawing pipe 60 because they are hydrolyzed as they are in the water treatment tank 10 and no excess sludge is generated. The shape and material of the scraping member 251 are not particularly limited as long as it can scrape off excessive microorganisms. For example, as shown in FIG. 5, it may have a simple rod shape. In this case, the scraping member 251 may be rotatably placed with one end (left end in figure) of the scraping member 251 as a rotation fulcrum, and at a normal time, the scraping member may be rotated anticlockwise to make the scraping member 251 retreat against the flat plate 20, and upon receiving a removal command, the scraping member 251 may be rotated clockwise so as to scrape off excessive microorganisms at the position shown in FIG. 5.

Note that ultrasonic cleaning, vibration, or the like may be applied as another microorganism removal mechanism for the flat plate 20. Alternatively, the above-described microorganism removal mechanism may be optionally combined and carried out. Thus, in the first embodiment, microorganisms are removed from the flat plate 20 by applying a physical action to the flat plate 20.

### Second Embodiment

The second embodiment is to kill some of the microorganisms adhering to the flat plate 20 and reduces the amount of the microorganisms. That is, as a removal section of excessive microorganisms, a microorganism killing mechanism for killing excessive microorganisms on the flat plate 20 is provided.

FIG. 6 is a view showing the configuration of a water treatment apparatus 400 according to the second embodiment as viewed from the introduction side of the raw water w. As shown in FIG. 6, the removal section 350 of the water treatment apparatus 400 of the present embodiment has a steam ejection section 351. The steam ejection section 351 is placed near the flat plate 20, and upon receiving a heating command, ejects high-temperature steam s to a part of the flat plate 20 not immersed in the raw water w. The ejection of the high-temperature steam s by the steam ejection section 351 is performed while the flat plate 20 is rotated, it becomes possible to kill excessive microorganisms on the flat plate 20. The high-temperature steam s mentioned here is steam having a temperature of 65° C. or higher, and the temperature is most preferably near 100° C. (temperature at which most bacteria are killed). This is because it is possible to save only Bacillus bacteria on the flat plate 20, which is useful for water treatment, and to kill other microorganisms. Because Bacillus bacteria have a habit to form spore, Bacillus that became spores can withstand a high-temperature of 100° C. or higher. Therefore, when the periphery of the flat plate 20 is heated to near 100° C. by high-temperature steam, excessive microorganisms are killed but only the spores of Bacillus survive.

The spores of Bacillus germinate in an environment with supply of food that is an organic matter and optimum temperature where ejection of the steam s by the steam ejection section 351 has ended, become nutrient cells, and start to purify water. The cumulative heating time is desirably 10 minutes or less per square centimeter. Too long heating time causes non-excessive microorganisms inside the flat plate 20 to be killed. The microorganisms killed by heating are naturally exfoliated from the flat plate 20 and decomposed by microorganisms in water or adhering to the flat plate 20.

In the present embodiment, by ejecting steam onto the surface of the flat plate 20, it becomes possible to save only microorganisms (Bacillus bacteria) useful for water treatment and to remove other excessive microorganisms.

Since it is possible to remove the microorganisms excessively adhering to the flat plate 20, it is possible to stabilize the water treatment performance (prevention of deterioration of treated water quality).

Furthermore, it is possible to reduce the workload of the maintenance manager of the water treatment facility (manpower saving).

### Modification 1 of Second Embodiment

In the modification 2 of the second embodiment, unlike the above-described second embodiment, the removal section has an ultraviolet irradiation mechanism.

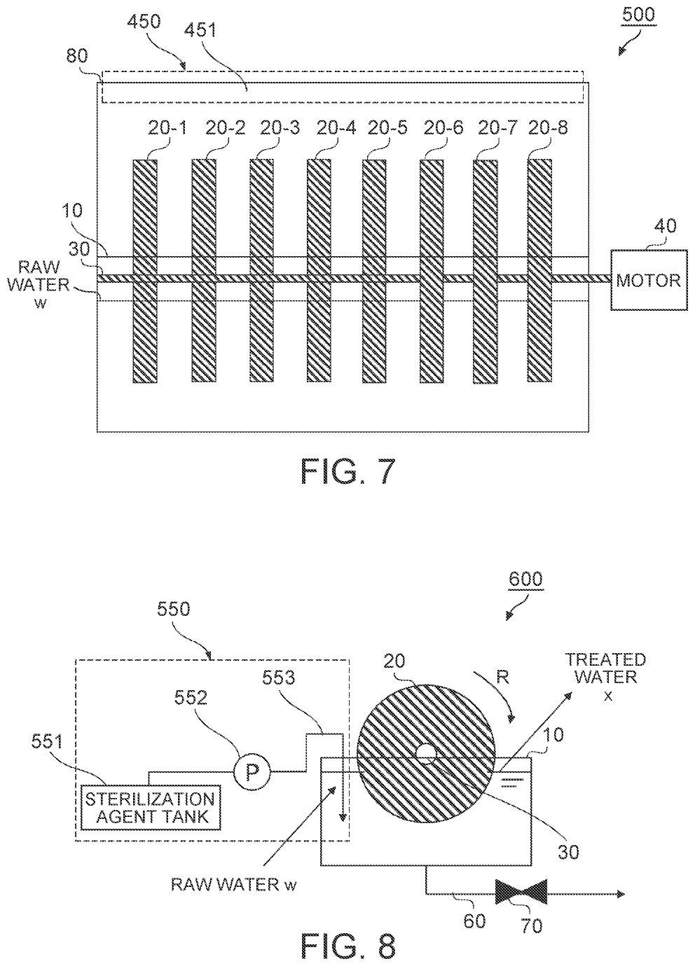

FIG. 7 is a view showing the configuration of a water treatment apparatus 500 of the modification 1 of the second embodiment as viewed from the side surface side. In the water treatment apparatus 500 of the modification 1 of the second embodiment, as shown in FIG. 7, a removal section 450 has an ultraviolet irradiation section 451. The ultraviolet irradiation section 451 of the removal section 450 has an ultraviolet irradiation mechanism capable of generating and irradiating ultraviolet rays. The water treatment apparatus 500 has the housing cover 80, and the ultraviolet irradiation section 451 may be attached to the housing cover 80. The ultraviolet irradiation section 451 is placed near the flat plate 20, and upon receiving an irradiation command, the ultraviolet irradiation section 451 operates to kill excessive microorganisms on the flat plate 20. Ultraviolet light has the ability to destroy microbial DNA. Immediately after ultraviolet irradiation, the microorganisms hardly change, but with the passage of time, the excessive microorganisms irradiated with ultraviolet rays are killed. The killed microorganisms are naturally exfoliated from the flat plate 20 and decomposed by microorganisms in the raw water w or microorganisms adhering to the flat plate 20. The ultraviolet irradiation amount is desirably 3.8 mJ/cm² or more in order to kill microorganisms.

### Modification 2 of Second Embodiment

In the modification 2 of the second embodiment, unlike the above-described second embodiment, the removal section has a sterilization agent charging mechanism.

FIG. 8 is a view showing the configuration of a water treatment apparatus 600 of the modification 2 of the second embodiment as viewed from the introduction side of the raw water w. The removal section 550 includes, for example, a sterilization agent tank 551, a chemical injection pump 552, and a sterilization agent injection section 553. The sterilization agent tank 551 is a container that accommodates the sterilization agent. The chemical injection pump 552 is a pump that sucks the sterilization agent from the sterilization agent tank 551 and sends it to the sterilization agent injection section 553. The sterilization agent injection section 553 is a pipe for injecting the sterilization agent sent from the chemical injection pump 552 into the water treatment tank 10 (tank). The removal section 550 injects a sterilization agent into the water treatment tank 10 containing the raw water w to kill excessive microorganisms. The sterilization agent may be any one as long as it kills excessive microorganisms. Examples of the sterilization agent include, but not limited to, a chlorine-based sterilization agent, an amine-based sterilization agent, an iodine agent, and a hydrogen peroxide agent.

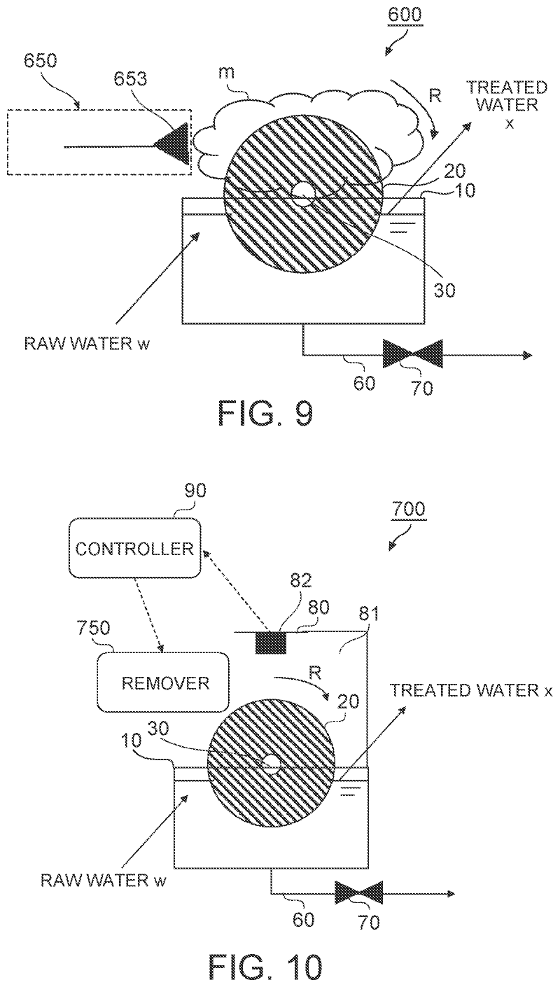

FIG. 9 is a view showing the configuration of the sterilization agent ejection section in the water treatment apparatus 600 of the modification 2 of the second embodiment. The mechanism for charging the sterilization agent into the water treatment tank 10 may be of any method, not limited to the direct charging by the chemical injection pump 552, for example, but as shown in FIG. 9, the sterilization agent may be applied by being ejecting directly onto the surface of the flat plate 20 in the form of mist. This is achieved by changing the configuration of the water treatment apparatus 600 of the modification 2 of the second embodiment from the sterilization agent injection section 553 to a sterilization agent ejection section 653. The sterilization agent ejection section 653 is a mechanism capable of ejecting the sterilization agent onto the surface of the flat plate 20 in the form of mist.

The water treatment apparatus 600 according to the modification 2 of the second embodiment is effective when bulking occurs due to a large amount of filamentous fungi being generated in the flat plate 20 or the aeration tank in the subsequent stage of the water treatment tank 10, in particular. When a large amount of filamentous fungi is generated, the sedimentation property of sludge is remarkably lowered, separation of the treated water x and the sludge becomes difficult, and the quality of the treated water x deteriorates. When filamentous fungi adhere to the surface of the flat plate 20, they form a microbial film very difficult to be exfoliated. Enlargement of the biofilm causes the entire flat plate 20 to be covered, breathability and water permeability are lowered, thereby leading to lowering of water treatment performance. A polyethylenepolyamine dimethylamine epichlorohydrin polycondensation or the like, which is a sterilization agent effective for sterilization of filamentous fungi and has relatively little influence on other effective microorganisms, has already been developed. Charged by the sterilization agent charging mechanism described above, the sterilization agent can prevent deterioration of processing performance due to a large amount of filamentous fungi generated.

The modification 2 of the second embodiment can remove filamentous fungi that adversely affect water treatment.

Note that ultrasonic crushing, drying treatment, or the like may be applied as another microorganism killing mechanism for the flat plate 20. In addition, the microorganism killing mechanism of the second embodiment may be optionally combined and carried out. Furthermore, the microorganism removal mechanism of the first embodiment and the microorganism killing mechanism of the second embodiment may be optionally combined and carried out, and by combining them, excessive microorganisms can be removed more efficiently in a shorter time.

### Third Embodiment

The third embodiment further includes an imaging section 82 (imaging device), and stops the function of the removal section 750 according to the image of the flat plate 20 imaged by the imaging section 82.

FIG. 10 is a view showing the configuration of a water treatment system 700 according to the third embodiment as viewed from the introduction side of the raw water w.

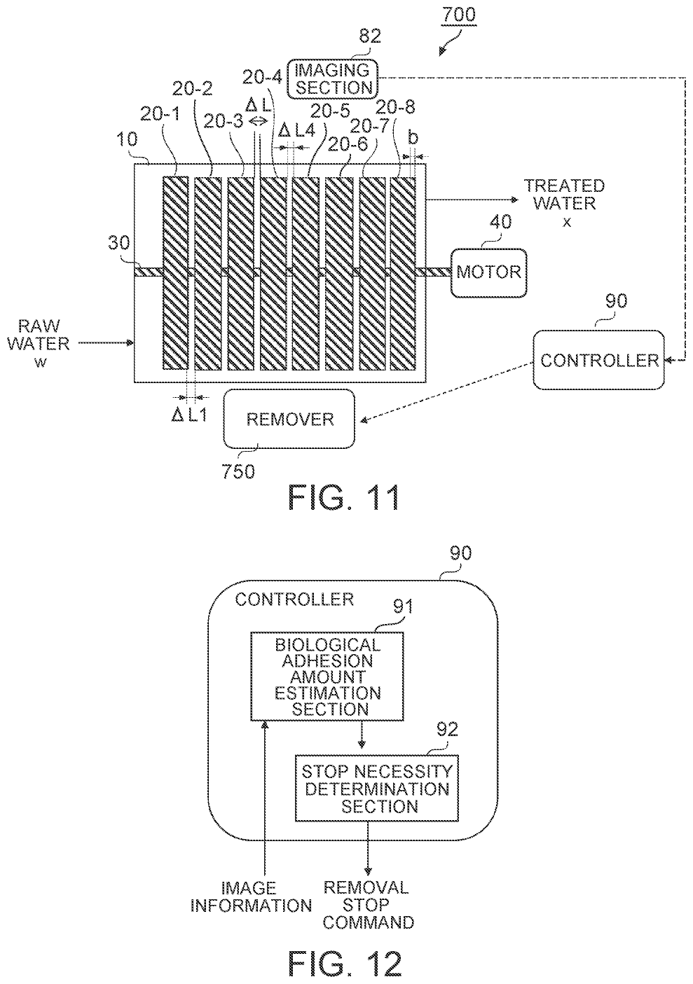

FIG. 11 is a view showing the configuration of the water treatment system 700 according to the third embodiment as viewed from above.

FIG. 12 is a block diagram showing the functional configuration of the control section 90 (controller) in the water treatment system 700 according to the third embodiment.

In the water treatment system 700 of the present embodiment, as illustrated in FIG. 10, the upper part of the water treatment tank 10 is covered with the housing cover 80, and an imaging section 82 such as a CCD camera is placed in a gas phase section 81, which is a space formed inside the housing cover 80. The water treatment system 700 of the present embodiment has a removal section 750 as the removal sections 50, 150, 250 of the water treatment devices 100, 200, 300 in the first embodiment or the removal sections 350, 450, 550 of the water treatment devices 400, 500, 600 in the second embodiment. The removal section 750 is either the removal section 50, 150, 250 in the first embodiment or the removal unit 350, 450, 550 in the second embodiment.

As shown in FIGS. 10 and 11, the difference between the water treatment apparatus 100, 200, 300 of the first embodiment or the water treatment apparatus 400, 500, 600 of the second embodiment and the water treatment apparatus 700 of the third embodiment is that the water treatment system 700 of the third embodiment includes the imaging section 82 and a control section 90 (controller). FIG. 10 shows an example in which the imaging section 82 is fixed to the inner surface of the top plate of the housing cover 80, but the imaging section 82 may be fixed to the inner surface of the side plate of the housing cover 80, or may be fixed to a dedicated fixing member (not illustrated) other than the housing cover 80 as long as it is within the gas phase section 81.

Note that FIG. 11 expresses as if the imaging section 82 comes off from the upper part of the water treatment tank 10, but this is done only for convenience in order to avoid complication of the drawing, and in reality, as shown in FIG. 10, the imaging section 82 is provided on the upper side of the water treatment tank 10.

In the water treatment system 700, as in the first embodiment or second embodiment, due to the function of the removal section 750, reduces the amount of microorganisms adhering to the surface of the flat plate 20, and the intervals between the flat plates 20 adjacent to each other increases. Let the interval between the flat plates 20 adjacent to each other in a state where microorganisms do not adhere at all be L, and let the interval between the flat plates 20 adjacent to each other in a state where microorganisms adhere be ΔL(L>ΔL).

The imaging section 82 images such a state of the flat plate 20 from the upper side of the flat plate 20 in the gas phase section 81, and outputs image information g of the imaged flat plate 20 to a biological adhesion amount estimation section 91 (organism adhesion amount estimation section) of the control section 90 as shown in FIG. 12. The color tone of the image included in the image information g varies greatly depending on the presence or absence of microorganisms.

The biological adhesion amount estimation section 91 of the control section 90 may perform image analysis on the image information g, may digitize the image information g to estimate the amount of microorganisms, and may stop the function of the removal section 750 of reducing the amount of microorganisms adhering to the flat plate 20. For example, when the removal section 750 kills microorganisms by steam heating, the protein contained in the microorganisms is discolored by heat. When this color change has a similar numerical value to that of a stop condition set in advance in a stop necessity determination section 92 (stop necessity judgment section) of the control section 90, the stop timing is controlled by using color information of the biofilm such as outputting a removal stop command (command to stop removal). When, for example, red, green, and blue in the RGB values match the set values as the color determination criteria, it is determined that the killing of the microorganisms is sufficient, and a removal stop command is output.

For example, a processor is used for the biofouling amount estimation section 91 and the stop necessity determination section 92. The processor consists of, for example, a CPU (Central Processing Unit). The biological adhesion amount estimation section 91 performs various processes based on a program or the like stored in memory or storage. In other words, the biological adhesion amount estimation section unit 91 and the stop necessity determination section 92 execute various programs as software function units. Instead of a CPU, an ASIC (Application Specific Integrated Circuit) or FPGA (Field Programmable Gate Array) may be used as a hardware functional part of the biological adhesion amount estimation section 91 and the stop necessity determination section 92. These can be used in place of the CPU. The same is true for the biological adhesion amount estimation section 191, 291, 391 and the stop necessity determination section 192, 292, 392.

The biological adhesion amount estimation section 91 of the control section 90 may perform image analysis on the image information g, may digitize the image information g to estimate the gap interval ΔL for each interval L. As described above, since the color tone of the image included in the image information g varies greatly depending on the presence or absence of microorganisms, the biological adhesion amount estimation section 91 can easily and accurately estimate the gap interval ΔL by using the difference in color tone.

The biological adhesion amount estimation section 91 can also estimate a film thickness b of the adhering microorganisms for each flat plate 20 by (L−ΔL)/2 on the basis of an assumption that the microorganisms proliferate uniformly even though some variation if any. Since the accuracy of the gap interval ΔL is high, the film thickness b is also estimated similarly with high accuracy.

The biological adhesion amount estimation section 91 outputs the intervals ΔL of all the gaps to the stop necessity determination section 92. Alternatively, instead of or in addition to the gap interval ΔL, the film thickness b may be output to the stop necessity determination section 92. Furthermore, the image information g may be output to a display section (not illustrated). This allows the operator to observe the image information g from the display section, and hence the operator can visually grasp the degree of adhesion of the microorganisms to the flat plate 20.

It should be noted that the digitization of the image information g does not necessarily have to be carried out by the biological adhesion amount estimation section 91. Instead of being carried out by the biological adhesion amount estimation section 91, the digitization of the image information g may be carried out by a function incorporated in the imaging section 82 or by another external computing device. If the imaging section 82 or another external computing device performs digitization, the imaging section 82 or another external computing device having performed the digitization outputs the result of the digitization to the biological adhesion amount estimation section 91. By using the result of the digitization, the biological adhesion amount estimation section 91 determines the gap interval ΔL and the film thickness b calculated from the gap interval ΔL as mentioned above for each interval L.

The stop necessity determination section 92 sums up the intervals ΔL of all the gaps having been output from the biological adhesion amount estimation section 91. Then, if the result of the sum is equal to or greater than a predetermined value, it is determined that the removal section 750 has removed the microorganisms excessively adhering to the flat plate 20, and a removal stop command is output to the removal section 750.

Alternatively, the stop necessity determination section 92 may select a representative gap interval ΔL from the gap intervals ΔL having been output from the biological adhesion amount estimation section 91, and if the selected gap interval ΔL is equal to or greater than a predetermined value, the stop necessity determination section 92 may determine that the removal section 750 has removed the microorganisms excessively adhering to the flat plate 20, and may output a removal stop command.

As an example of a case of selecting a representative gap interval ΔL, for example, on the above-described assumption that the microorganisms proliferate uniformly even though some variation if any, a void interval ΔL4 between two adjacent flat plates 20-4 and 20-5 existing on the center side in the water treatment system 700 can be selected as the representative void interval ΔL.

Alternatively, a gap interval ΔL1 between the left-most flat plate 20-1 and the flat plate 20-2 second from the left in FIG. 11 may be the representative gap interval ΔL. This is because the raw water w is introduced into the water treatment tank 10 from the left side in FIG. 11, and hence it is assumed that a larger number of microorganisms adhere to the flat plate 20 to the left side in FIG. 11.

If the selected gap interval ΔL is equal to or greater than a predetermined value, the stop necessity determination section 92 outputs a removal stop command that stops the function of the removal section 750 to reduce the amount of microorganisms adhering to the flat plate 20.

As an example of a specific determination criterion for removal section stop necessity based on a single gap interval ΔL, if the interval L between the flat plates 20 adjacent to each other is 5 cm, a removal stop command is output when the gap b interval ΔL becomes 4 cm or more.

As described above, the water treatment system 700 of the present embodiment can determine the necessity of stopping the function of the removal section 750 in accordance with the gap interval ΔL and the film thickness b estimated based on the image information g imaged by the imaging section 82.

In the water treatment system 700, the imaging section 82 is placed in the gas phase section 81 and images the state of the flat plate 20 from the gas phase section 81, and hence the imaged image information g is clear. Therefore, the gap interval ΔL and the film thickness b can be estimated with high accuracy, and it becomes possible for the stop necessity determination section 92 to determine the removal stop necessity with high reliability.

Since the imaging section 82 is placed not in water but in the gas phase section 81, the cleaning of the imaging section 82 only requires automatic cleaning by a wiper, and can be operated almost without maintenance.

Furthermore, since the image information g can be displayed on the display section such as a display, the operator of the water treatment system 700 can visually grasp the degree of adhesion of the microorganisms to the flat plate 20 by confirming the image information g displayed on the display section.

Thus, as in the water treatment system 700 of the present embodiment, by providing a configuration including the imaging section 82 and determining, in accordance with the image information g, whether or not the amount of microorganisms excessively adhering to the flat plate 20 has been successfully removed by the function of the removal section 750, it becomes possible to reduce the maintenance management cost, to save labor, to improve the efficiency of operation, and to simplify the configuration without generating an extra maintenance labor by introducing the imaging section 82.

### Modification 1 of Third Embodiment

The modification 1 of the third embodiment is, unlike the above-described third embodiment, a water treatment system 800 that stops the function of the removal section in accordance with the current measured by the ammeter.

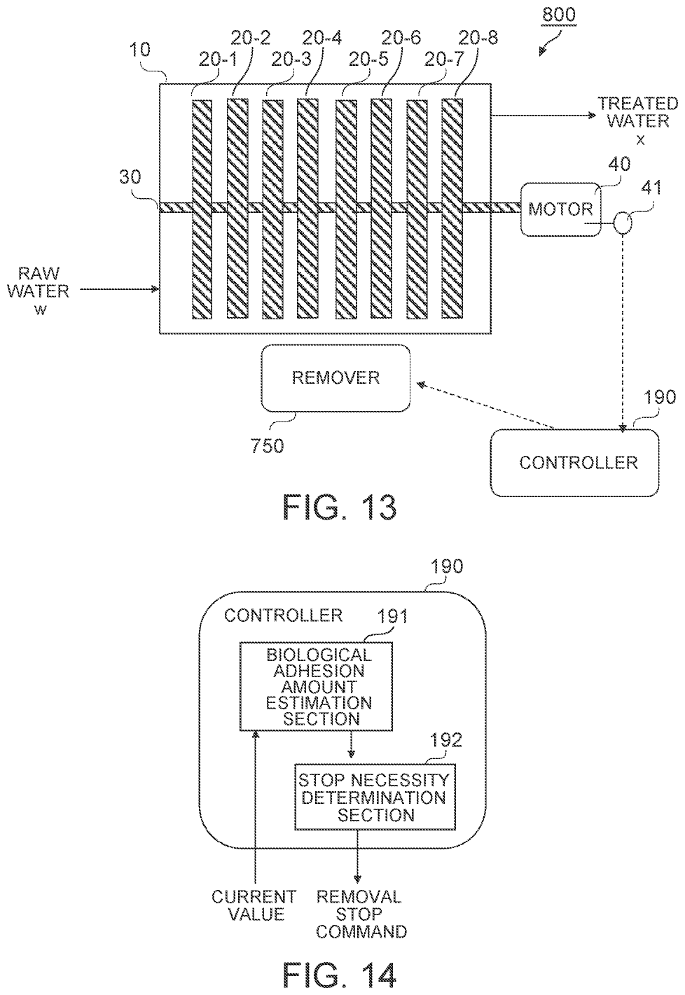

FIG. 13 is a view showing the configuration of a water treatment system 800 of the modification 1 of the third embodiment as viewed from above. The difference in configuration between the water treatment system 800 in the modification 1 of the third embodiment and the water treatment system 700 in the third embodiment lies in that the former includes an ammeter 41 instead of the imaging section 82. In the water treatment system 800, as in the water treatment system 700 according to the third embodiment, the motor 40 rotates the flat plate 20. The ammeter 41 is connected to the motor 40, and the ammeter 41 continuously measures the motor current of the motor 40 at the time of driving.

FIG. 14 is a block diagram showing the functional configuration of the control section 190 in the water treatment system 800 according to the modification 1 of the third embodiment. The ammeter 41 outputs the measured current value to the biological adhesion amount estimation section 191 of the control section 190.

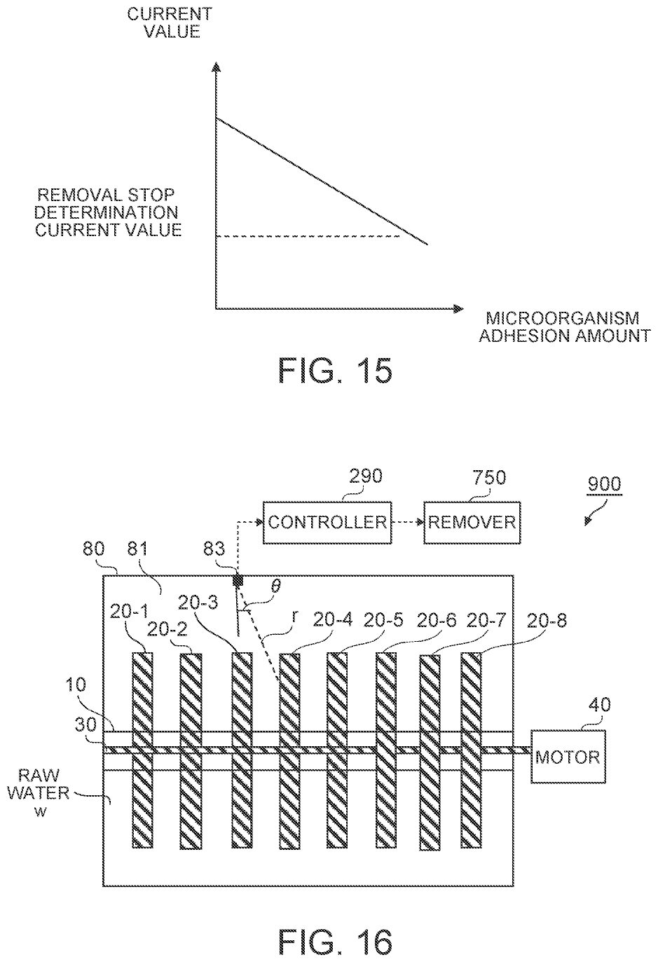

FIG. 15 is a graph illustrating the relationship between the amount of microorganisms adhering to the flat plate 20 and the motor current value obtained when the flat plate 20 rotates, when the number of rotations per unit time is the same.

As the amount of microorganisms adhering to the flat plate 20 is reduced, the torque when rotating the flat plate 20 is lowered. Therefore, as illustrated in FIG. 15, when the number of rotations per unit time is maintained at a constant number of rotations, the current value measured by the ammeter 41 decreases with a decrease in the amount of microorganism adhesion. The smaller the microorganism adhesion amount is, the smaller the film thickness b of the flat plate 20 becomes.

Based on the relationship illustrated in FIG. 15, the biological adhesion amount estimation section 191 estimates the film thickness b of the microorganisms adhering to the flat plate 20 as the amount of the microorganisms adhering to the flat plate 20 from the current value measured by the ammeter 41. The biological adhesion amount estimation section 191 also outputs the estimated film thickness b to the display section (not illustrated), and outputs the current value and the film thickness b to a stop necessity determination section 192.

The operator can confirm the film thickness b estimated by the biological adhesion amount estimation section 191 from the display section.

If the current value from the biological adhesion amount estimation section 191 is lower than the removal stop determination current value shown in FIG. 15, the stop necessity determination section 192 assumes that the amount of microorganisms excessively adhering to the flat plate 20 has been sufficiently reduced, and outputs, to the removal section 750, a removal stop command that stops the function of the removal section 750 to reduce the amount of microorganisms excessively adhering to the flat plate 20.

### Modification 2 of Third Embodiment

The modification 2 of the third embodiment is, unlike the above-described third embodiment, a water treatment system that stops the function of the removal section in accordance with the distance measured by the distance meter.

FIG. 16 is a view showing the configuration of a water treatment system 900 of the modification 2 of the third embodiment as viewed from the side surface side. As shown in FIG. 16, the water treatment tank 10 is covered with the housing cover 80, and in the gas phase section 81, a laser distance meter 83 is provided.

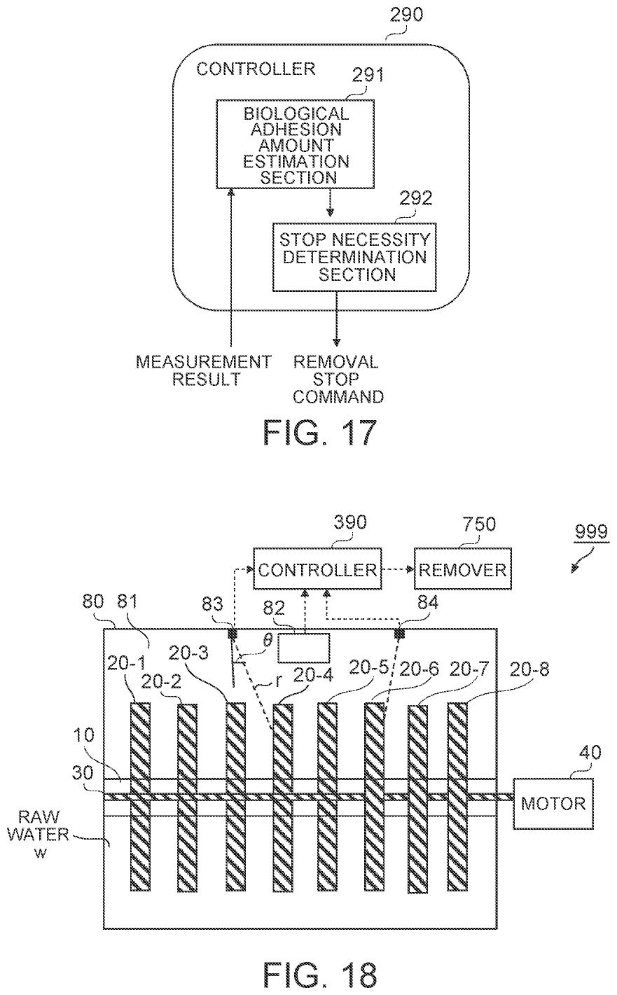

FIG. 17 is a block diagram showing the functional configuration of the control section 290 in the water treatment system 900 according to the modification 2 of the third embodiment. The laser distance meter 83 measures the distance to the microorganisms adhering to the flat plate 20 selected as the representative, and outputs the measurement result to a biological adhesion amount estimation section 291 of a control section 290. As a selection method of the representative flat plate 20, as described above, on the above-described assumption that the microorganisms proliferate uniformly even though some variation if any, as shown in FIG. 16, the flat plate 20-4 on the center side can be used as a representative.

The biological adhesion amount estimation section 291 estimates the adhesion amount of microorganisms based on the measurement result from the laser distance meter 83. Since the location where the laser distance meter 83 is provided is known, the distance and direction from the laser distance meter 83 to the representative flat plate 20-4 are also known in advance. This direction corresponds to an irradiation angle θ (angle with respect to the vertical direction) shown in FIG. 16. Therefore, the biological adhesion amount estimation section 291 can estimate the film thickness b of the microorganisms adhering to the representative flat plate 20-4 by using the distance and orientation from the laser distance meter 83 to the representative flat plate 20-4 and the measurement result from the laser distance meter 83. Instead of the laser distance meter 83, a reflection type photoelectric distance sensor may be applied. The reflection type photoelectric distance sensor projects visible light or infrared light onto, for example, the surface of the representative flat plate 20-4 and receives reflected light, thereby measuring the distance to the surface of the flat plate 20-4. The biological adhesion amount estimation section 291 can estimate the film thickness b of the microorganisms adhering to the representative flat plate 20-4 also based on the measurement result obtained by such the photoelectric distance sensor, similarly to the measurement result from the laser distance meter 83. The biological adhesion amount estimation section 291 outputs the estimated film thickness b to a stop necessity determination section 292.

Based on the estimated film thickness b, the stop necessity determination section 292 determines the necessity of stopping the function of the removal section 750 to reduce the amount of the microorganisms excessively adhering to the flat plate 20. Since the other configurations are as described above, the description is omitted.

Thus, according to the present modification, the laser distance meter 83 or a photoelectric distance sensor can also be applied.

In order to acquire information necessary for estimating the film thickness b of the microorganisms adhering to the flat plate 20, the imaging section 82, the laser distance meter 83, and a photoelectric distance sensor 84 may be applied together.

### Modification 3 of Third Embodiment

The modification 3 of the third embodiment is, unlike the above-described third embodiment, a water treatment system stops the function of the removal section in accordance with the distance measured by the imaging section, the distance meter, and the photoelectric distance sensor.

FIG. 18 is a view showing the configuration of the water treatment system of the modification 3 of the third embodiment as viewed from the side surface side. As shown in FIG. 18, the upper part of the water treatment tank 10 of a water treatment system 999 is covered with the housing cover 80 as in FIG. 16, and in the gas phase section 81, the imaging section 82, the laser distance meter 83, and the photoelectric distance sensor 84 are installed at appropriate locations.

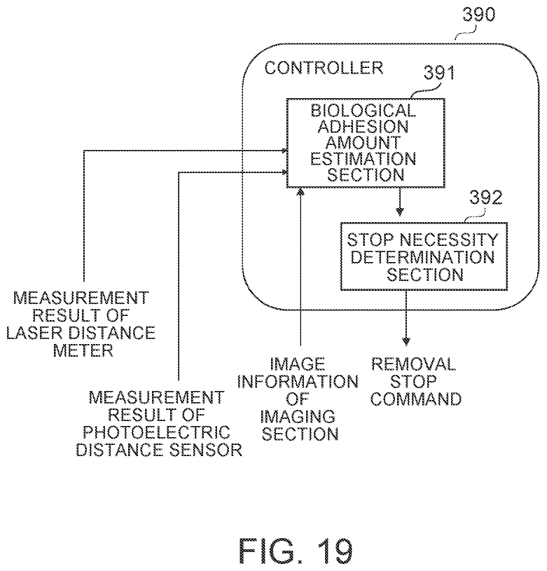

FIG. 19 is a block diagram showing the functional configuration of the control section 390 in the water treatment system according to the modification 3 of the third embodiment.

The imaging section 82 outputs the image information g to a biological adhesion amount estimation section 391 of a control section 390. As described above, the laser distance meter 83 outputs, to the biological adhesion amount estimation section 391, the distance to the surface of the representative flat plate 20-4, which is the measurement result.

The photoelectric distance sensor 84 outputs, to the biological adhesion amount estimation section 391, the distance to the surface of the representative flat plate 20-6, which is the measurement result.

As described above, the biological adhesion amount estimation section 391 estimates the film thickness b from the image information having been input from the imaging section 82. As described above, the biological adhesion amount estimation section 391 also estimates film thickness b from different measurement results having been input from the laser distance meter 83 and the photoelectric distance sensor 84.

In this manner, the biological adhesion amount estimation section 391 can estimate three film thicknesses b at the same time. Then, the three film thicknesses b estimated at the same time are all output to a stop necessity determination section 392.

The stop necessity determination section 392 outputs a removal stop command if any value or the average value of the three film thicknesses b having been output at the same time is smaller than a predetermined value.

Such a configuration can determine a state in which the amount of microorganisms excessively adhering to the flat plate 20 has been reduced, and can output a removal stop command to the removal section 750. Even when any of the imaging section 82, the laser distance meter 83, and the photoelectric distance sensor 84 break down, it is possible to estimate the film thickness b of the microorganisms, and output a removal stop command where necessary.

The case where all of the imaging section 82, the laser distance meter 83, and the photoelectric distance sensor 84 are used has been described above, but any two of them may be used. The configuration in which two of the imaging section 82, the laser distance meter 83, and the photoelectric distance sensor 84 are used can also estimate the film thickness b of the microorganisms and can output a removal stop command even if one of them fails.

Thus, according to the first to third embodiments, it is possible to provide a water treatment apparatus 100, 200, 300, 400, 500, 600 and a water treatment system 700, 800, 900, 999 that can remove, such as reliably exfoliate (peel off) or kill, microorganisms excessively adhering to the surface of a flat plate 20, and cause the flat plate to maintain a high removal rate at all times with respect to an object to be removed such as organic matters, nitrogen, and phosphorus by bringing oxygen and raw water into contact with microorganisms inside of the flat plate 20.

Although some embodiments of the present invention have been described, these embodiments are presented by way of example and are not intended to limit the scope of the invention. These novel embodiments can be implemented in various other forms, and various omissions, substitutions, and changes can be made without departing from the gist of the invention. These embodiments and modifications thereof are included in the scope and gist of the invention, and are also included in the scope of the invention described in the claims and equivalents thereof.

What is claimed is:

1. A water treatment apparatus, comprising:
a flat plate rotating so as to be partially immersed in raw water and to which microorganisms that purify the raw water adhere; and
a remover configured to remove part of the microorganisms adhering to the flat plate.

2. The water treatment apparatus according to claim 1, wherein
the remover removes part of the microorganisms adhering to the flat plate by applying a physical action to the flat plate.

3. The water treatment apparatus according to claim 2, wherein
the remover cleans the flat plate by causing bubbles to collide with an immersed part of the flat plate.

4. The water treatment apparatus according to claim 2, wherein
the remover cleans the flat plate by ejecting fluid onto the flat plate.

5. The water treatment apparatus according to claim 4, wherein
the fluid is treated water in which the raw water has been purified by the microorganisms.

6. The water treatment apparatus according to claim 2, wherein
the remover peel off the microorganisms from the flat plate by pressing a scraping member against a surface of the flat plate.

7. The water treatment apparatus according to claim 1, wherein
the remover has a microorganism killing mechanism that kills part of the microorganisms adhering to the flat plate.

8. The water treatment apparatus according to claim 7, wherein
the microorganism killing mechanism kills part of the microorganisms by ejecting high-temperature steam to a part of the flat plate that is not immersed in raw water.

9. The water treatment apparatus according to claim 7, wherein
the microorganism killing mechanism kills part of the microorganisms by irradiating the flat plate with ultraviolet rays.

10. The water treatment apparatus according to claim 7, wherein
the microorganism killing mechanism kills part of the microorganisms by injecting a sterilization agent into a tank containing the raw water.

11. The water treatment apparatus according to claim 7, wherein
the microorganism killing mechanism kills part of the microorganisms by ejecting a sterilization agent onto the flat plate surface.

12. A water treatment system, comprising:
a water treatment apparatus according to claim 1;
an imaging section that images the flat plate; and
a controller that stops a function of the remover to remove part of the microorganisms adhering to a flat plate in accordance with an image of a flat plate imaged by the imaging device.

13. A water treatment system, comprising:
a water treatment apparatus according to claim 1;
an ammeter that measures a current of a motor used for rotation of the flat plate; and
a controller that stops a function of the remover to remove part of the microorganisms attached to a flat plate in accordance with a current measured by the ammeter when the flat plate is rotated at a constant number of rotations.

14. A water treatment system, comprising:
a water treatment apparatus according to claim 1;
a distance meter that measures a distance to a surface of a microbial film adhering to the flat plate; and
a controller that stops a function of the remover to remove part of the microorganisms adhering to a flat plate in accordance with a distance measured by the distance meter.
